(19) United States
(12) Patent Application Publication
(10) Pub. No.: US 2026/0300680 A1
(43) Pub. Date: Oct. 1, 2026

(54) WEIGHT VECTOR QUANTIZATION FOR NEURAL NETWORKS

(71) Applicant: Amazon Technologies, Inc., Seattle, WA (US)

(72) Inventors: Qiuwen Lou, Mountain View, CA (US); Tong Qin, Ann Arbor, MI (US); Sankalp Dayal, San Mateo, CA (US); Tariq Afzal, San Jose, CA (US); Rahul Bakshi, San Jose, CA (US)

(21) Appl. No.: 19/096,250

(22) Filed: Mar. 31, 2025

(51) Int. Cl. G06N 3/04

(52) U.S. Cl. CPC G06N 3/04

(57) ABSTRACT

Devices and techniques are generally described for vectorwise weight quantization for neural networks. In some examples, a first index vector stored in volatile memory may be determined for a first layer of a neural network. First code data may be determined by performing a lookup using the first index vector as an index into a codebook. A first weight vector may be determined by decoding the first code data using a first decoding algorithm. Each element of the first weight vector may represent a respective weight for the first layer of the neural network. An output for the first layer of the neural network may be computed using the weights of the first weight vector.

### BACKGROUND

Machine learning techniques are used to form predictions, solve problems, recognize objects in image data for classification, etc. For example, machine learning techniques may be used to detect objects represented in image data, generate text, images, translate text from one human understandable language to another, etc. In various examples, machine learning models may be improved over time by retraining the models as more or different data becomes available. Accordingly, machine learning techniques are adaptive to changing conditions. Deep learning algorithms, such as neural networks, are sometimes used to detect patterns in data and/or perform tasks.

### BRIEF DESCRIPTION OF DRAWINGS

FIG. 1 is a block diagram of an example machine learning accelerator architecture that may include a decompression system for weight vector quantization, according to various embodiments of the present disclosure.

FIG. 2 depicts an example of weight vector quantization that may be used by various systems and techniques of the present disclosure.

FIG. 3 depicts an example process for weight loading and decoding, in accordance with various examples of the present disclosure.

FIG. 4 depicts an example process for determining a full precision weight vector from a quantized index weight vector for inference processing, in accordance with various aspects of the present disclosure.

FIG. 5 is a block diagram showing an example architecture of a network-connected device that may be used in accordance with various aspects described herein.

FIG. 6A depicts an example of the decompression system of FIG. 1 that may be included in an example machine learning accelerator architecture, in accordance with various aspects of the present disclosure.

FIG. 6B depicts an example usage of the decompression system of FIG. 6A for decoding full precision weights from quantized weights, quantized using the Quantization with incoherence processing (QuIP #) algorithm, in accordance with an example of the present disclosure.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Artificial intelligence systems including various machine learning models are currently being developed and deployed for a wide variety of use cases, including generative models such as language models (e.g., large language models (LLMs)), image/video generation models (e.g., latent diffusion models), computer vision models, LLM-based agents, neural network-based classifiers, etc. Such machine learning models can be executed on general purpose processors and/or hardware accelerators using program code written in a specialized programming language such as TensorFlow, PyTorch, etc. The program code is converted into machine instructions by a compiler. In a neural network, the types of computations performed, and the data the computations are performed on, can be different from computations used for other things. For example, neural networks can involve repeated manipulation of large quantities of data representing tensors. The term tensor will sometimes be used herein in accord with its mathematical meaning, but will also sometimes be used herein to refer to stored data representing a tensor or a data structure storing data representing a tensor, e.g. a vector, matrix, or larger dimensional data structure. The term channel will sometimes be used herein to refer to a mathematically defined portion of a tensor, e.g. for a three dimensional tensor characterized as having rows, columns, and sheets (the term sheet is used here instead of the sometimes used term “channel” to avoid confusion), the term channel may refer to a row of a single sheet, a row of all sheets, a column of a single sheet, or a column of all sheets.

In various examples, during inference processing (e.g., by a neural network) data representing weights of the model (e.g., the model's parameter set, learned during training) may be loaded into volatile memory (e.g., static random access memory (SRAM)) for processing by a compute engine (e.g., an engine that performs matrix multiplication, vector multiplication, and/or accumulation of the results). Neural networks and/or other machine learning models may have a large number of layers, with each layer potentially having a number of neurons (sometimes referred to as “nodes”). In addition, the neurons in a given layer may be “connected” with neurons in preceding layers, subsequent layers, and/or other layers (e.g., “skip” connections). Each of these connections may be associated with a model weight that may be learned during training. As such, execution of a given machine learning model may require storage of a large number of weight values. If these weight values are stored in full-precision form (e.g., using 8-bits per parameter) the amount of memory required for storage of the weights may quickly become very large. For example, large language models (LLMs) currently employ between a billion and nearly two trillion parameters and the numbers of parameters may continue to expand as new models are developed and trained.

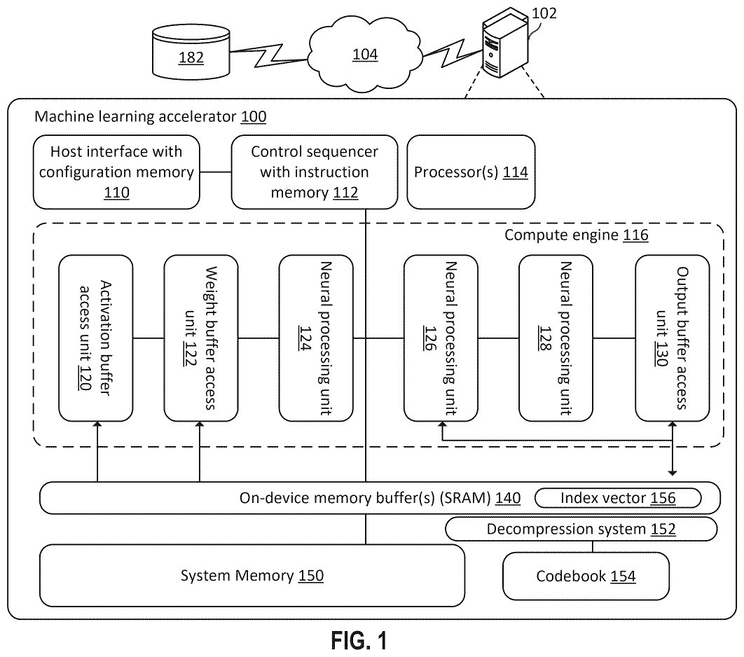

In addition to the large storage requirements of the model weights, many hardware accelerators (e.g., neural network accelerators (NNAs) such as the example described below in reference to FIG. 1) load the model weights into SRAM only when the particular weights are needed for computation. As such, loading full-precision weights from storage (e.g., double date rate (DDR) memory) into on-chip SRAM buffers may involve the movement of a large amount of data leading to both significant processing and power consumption by the NNA. Accordingly, it may be advantageous to compress model weights into quantized reduced-precision weight values and store the reduced-precision weight values in association with the model. For example, if a full-precision model weight is 16 bits, a reduced-precision weight value may be 4 bits, 3 bits, 2 bits, or even 1 bit.

Some conventional approaches may compress weight values element-by-element (e.g., compression may be performed per-weight). Such methods have been shown to quantize weights to as low a bit width as 1-2 bits per weight. However, model performance has been shown to suffer (when evaluated using common benchmark tests) when quantizing model weights to very low bit width (e.g., 1-2 bits, 1-3 bits, etc.) using element-by-element compression.

However, as described herein, various approaches may be used for weight vector quantization. Weight vector quantization refers to quantizing vectors of models weights together to generate a compressed weight vector. For example, a four element vector storing four full-precision (e.g., 32-bit) weight values may be compressed together using various weight vector quantization techniques to generate a quantized weight vector including four reduced-precision (e.g., 1 bit, 2 bits, 3 bits, etc.) weight values. The benefit of weight vector quantization is that weights can be aggressively compressed (e.g., to 1 or 2 bits) without sacrificing model performance (as evaluated using a variety of model benchmarking tests such as model accuracy, latency, etc.) as compared to element-by-element quantization where aggressive quantization to 1 or 2 bits has been shown to lead to significant degradation in model performance.

In many of the examples discussed herein, weight vector quantization discusses quantization of one-dimensional vectors. However, it should be appreciated that these techniques can be extended to higher-dimensional data structures such as matrices, tensors, etc. For example, N rows (or N columns) of a two-dimensional matrix could be considered N vectors that can be quantized. In another example, the N rows (or N columns) could be concatenated to form a single “column vector” that can be quantized using weight vector quantization. Tensors and/or other higher-dimensional data structures may be similarly decomposed in order to perform efficient weight vector quantization.

Weight vector quantization can use various different algorithms, as described in further detail below. Accordingly, depending on the weight vector quantization algorithm used, the decoding logic used to decompress (e.g., dequantize) the weight values may differ. As such, it may be advantageous to include components in the hardware accelerator (e.g., a NNA) that can be used to decode weights that have been quantized using a variety of different compression algorithms. Accordingly, described herein is a decompression system that may selectively decompress weight values quantized using a variety of different weight vector quantization techniques.

The various machine learning models described herein may be executed on a combination of physical and/or virtualized computing devices/resources. Physical computing resources may include, for example, hardware compute processing units (CPUs), hardware accelerators (e.g., graphics processing units (GPUs), neural processing units (NPUs), neural network accelerators (NNAs), physical memory, etc. Examples of virtualized computing resources may include virtualized CPUs, GPUs, NNAs, virtual memory, etc. Computing resources may include virtualized components executing on physical hardware. In some examples, the virtualized components and/or the physical hardware on which the virtualized components are executed may be distributed (e.g., geographically diverse). A collection of distributed compute services (e.g., of a given server instance) may be instantiated, for example, using a container orchestration framework, one or more virtual machines, physical hardware, etc. In some other examples, a given server instance may executed on the same hardware components (and may not be distributed). Accordingly, server instances may include components that are physical and/or virtual and which may be distributed and/or co-located. A configuration for a given server instance can refer to the different hardware (whether physical or virtualized) deployed on the server instance, the software deployed on the server instance, and/or the configurations thereof.

In various examples discussed herein, some of the computing devices described herein may be provisioned with and/or may employ accelerator hardware. In some cases, machine learning accelerators (and/or general processors, depending on the implementation) may be programmed to implement an inference engine (sometimes called a “compute engine”). An inference engine refers to programming a machine learning accelerator and/or general purpose processor (or processors) to execute the various operations of a particular machine learning model. Examples of such operations may include determining dot products of two vectors, vector addition, vector multiplication, matrix multiplication, forward and backward convolutions, pooling, etc. Inference engines may be implemented using machine learning accelerator hardware and/or other specialized processors (e.g., graphical processing units, tensor processing units).

Hardware accelerators may include a class of specialized hardware accelerators designed to accelerate machine learning applications by focusing on arithmetic operations and in-memory (e.g., in SRAM) computing capability. A neural network accelerator (NNA) architecture is an example of a machine learning accelerator hardware that has been designed to accelerate processing for neural networks. An example of a NNA is described below in reference to FIG. 1. A variety of different operations may be performed by a particular machine learning model during inference. As an example of machine learning operations (e.g., operations that may be optimized to improve performance using the various hardware and/or techniques described herein), a forward pass of a feed forward neural network is now described.

The forward pass involves a series of mathematical transformations that start at the input layer, propagate through one or more hidden layers, and culminate in the output layer. Input data, usually in the form of vectors (e.g., a numerical encoding of one or more inputs token representing words or sub-words, in the context of language models), is provided to the input layer of the model. In a fully-connected example, each neuron of the input layer is connected to each neuron of the subsequent first hidden layer. For each neuron of the input layer, the value is multiplied by a respective weight (a parameter learned during training). The weight value for a given input neuron is specific to that neuron's connection with a given neuron in the first hidden layer. For a given neuron in the first hidden layer, the weighted inputs are summed together and a bias term is added. The bias term allows the activation function to be shifted to the left or right (e.g., to be more negative or more positive). This summation result may be passed through an activation function (e.g., sigmoid, a rectified linear units (ReLu) function, tanh, etc.) to introduce non-linearity into the model. The resulting value is the activation value for the first neuron in the first hidden layer. This process is repeated for each neuron in the first hidden layer. Note that the weight values connecting nodes in the input layer may be different for each distinct neuron in the first hidden layer (and similarly for the connections between subsequent hidden layers and the output layer). As described herein, these weight values may be stored in quantized reduced-precision form (e.g., after compression using weight vector quantization). The quantized weight vectors may be used as an index vector as a key into a codebook. The code data retrieved from the codebook may be decoded (according to the weight vector quantization algorithm used to compress the weights) to generate the full-precision weight values which may be used by the compute engine to compute activation values during the forward pass (as described above).

The activation values for the neurons at the first hidden layer (and similarly for any hidden layer and the output layer) may be stored together in a data structure referred to herein as an activation tensor. In an activation tensor, each element may correspond to a neuron and the value of that element may be the current activation value for that neuron (generated for the current input). Since the inputs may be dynamic, these activation values change over time and are thus dynamic. However, activation values (and activation vectors, matrices, and/or tensors) may also be compressed and/or quantized. Additionally, activation vectors may also be used as an index into a codebook to retrieve code data that can be decoded to generate full-precision activation values. Accordingly, the various systems and techniques for weight vector quantization described herein may also be used for activation values.

As previously described, some current LLM architectures include over a trillion learnable parameters (e.g., weights). As such loading all of these weights into random access memory (e.g., SRAM) during processing involves loading a large amount of data into memory. The various weight vector quantization systems and techniques described herein may dynamically reduce the amount of data that is required to be stored (e.g., in system memory (e.g., DDR)) by storing only a relatively small codebook and the index vectors representing the quantized weight vectors. Additionally, the amount of data loaded from storage to memory (e.g., SRAM) may be dramatically reduced by loading only the aggressively quantized weight vectors (e.g., with 1 bit, 2 bit, 3 bit, etc., weight values) and/or the retrieved codes into memory and by computing the full-precision weight values in memory. Accordingly, the various techniques described herein lead to huge improvements in memory footprint, compute, throughput, and power consumption.

Machine learning techniques, such as those described herein, can be used to form predictions, solve problems, answer questions, recognize objects in image data for classification, generate images, video, and/or natural language data, etc. In various examples, machine learning models may perform better than rule-based systems and may be more adaptable as machine learning models may be improved over time by retraining the models as more and more data becomes available. Accordingly, machine learning techniques can adapt to changing conditions.

Generally, in machine learning models, such as neural networks, after initialization, annotated training data may be used to generate a differentiable cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is sometimes referred to herein as back propagation.

As previously described, the compute cost (in terms of compute resources used) for a given inference request may vary greatly depending on the complexity of the request and the particular machine learning model being deployed. Some examples of machine learning architectures which may be deployed for inference processing are now described. It should be noted that these examples do not constitute an exhaustive list and that the inference routing and/or complexity classification techniques described herein may be used with any desired machine learning model architectures.

### Language Models

A generative LM is an artificial intelligence (AI) model that may be capable of processing and generating human-like text based on the latent information it has learned from vast amounts of training data. In some cases, some LMs are referred to as “large” language models (LLMs). The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to process and generate more natural-sounding text (relative to previous approaches). LMs are typically trained on massive datasets that include a wide variety of text from various sources, enabling the LMs to “understand” grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), Claude by Antrhopic, as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training. The term “prompt” may refer to plain text or structured text, and may be provided via an interface to the LM, such as an API. The prompt may generally be written in natural language, expressed, for example, as if requesting a task to be performed by the LM (e.g., “Who is the current President of the United States?”). In some examples, contextual information may be provided (e.g., as part of the prompt) and/or may be retrieved (e.g., from external sources) by the LM (e.g., retrieval-augmented generation (RAG)) and used to respond to the prompt). In some examples, LMs may be instructed (e.g., using hidden prompts) as to how to use various external APIs and/or tools (e.g., online search engines and/or other software) that may, in turn, be used to perform actions responsive to user-input requests. LMs are often built using the transformer architecture, which is described in further detail below. It should be noted, however, that transformers may be used in other machine learning contexts beyond LMs.

### Transformer Models

Transformer models are employed in many different types of machine learning architectures, including many of the LMs previously described. Transformer models are machine learning models that include an encoder network and a decoder network. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions and/or generate a natural language response to the input (depending on the specific model being employed). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{{QK}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place—in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

The foregoing examples of machine learning processing tasks are merely examples to show the diversity (in terms of both the task and the complexity) of machine learning techniques. However, the weight vector quantization hardware and techniques described herein may be used with any machine learning tasks.

FIG. 1 is a block diagram of an example machine learning accelerator 100 that may include a decompression system 152 for weight vector quantization, according to various embodiments of the present disclosure. In various examples, one or more computing devices 102 may include and/or be used to execute the machine learning accelerator 100 and/or components thereof. Additionally, the various components of the one or more computing devices 102 implementing machine learning accelerator 100 may be a collection of compute services that are distributed in a cloud-based environment. The components of machine learning accelerator 100 may communicate with one another and/or with remote computing devices (such as the various server instances discussed herein) via a network 104. Network 104 may be a wide area network, such as the Internet, an intranet, a local area network (LAN), and/or some combination thereof. Non-transitory computer-readable memory 182 may store instructions that, when executed by one or more processors of the one or more computing devices 102 may be effective to instantiate the various components of machine learning accelerator 100 and/or perform the various techniques described herein. In various examples, the machine learning accelerator 100 may include or be configured in communication with system memory 150 (e.g., DDR, flash, etc.) that may store the weight vectors (and/or any other weight data structures such as matrices, tensors, etc.) of one or more trained machine learning models. The weight tensors may be quantized, post-training, using any desired weight vector quantization algorithm to low bit width (e.g., 1 bit, 2 bits, 3 bits, 4 bits, etc., depending on the desired quantization level). For example, the system memory 150 may store quantized weight vectors and/or quantized weight tensors that may be loaded into the on-device memory buffer(s) 140 when needed by the compute engine 116. Accordingly, in FIG. 1, the index vector 156 is shown in the on-device memory buffer(s) 140. Although system memory 150 is shown and described, any suitable memory (e.g., DRAM) may be used in accordance with the particular machine learning accelerator 100 hardware.

System memory 150 may the index vectors 156 representing various model weights quantized using weight vector quantization. When needed for compute, index vectors 156 (e.g., for the relevant layer of a neural network) may be loaded from system memory 150 into SRAM (e.g., on-device memory buffer(s) 140). In various examples, codebook 154 may be stored in separate memory relative to system memory 150 and/or on-device memory buffer(s) 140. As described in further detail below, the codebook 154 may store code data indexed by key values. The key values correspond to the quantized weight vectors (sometimes referred to herein as index vectors (e.g., index vector 156)) and the code data may be decoded (using the relevant decoding algorithm) by decompression system 152 to generate the full-precision weight vector that corresponds to the quantized weight vector of the key value. The terminology “full-precision” as used herein indicates the precision of weight value on which the compute engine 116 performs mathematical operations (e.g., post dequantization/decompression) and not necessarily the full-precision of the weight value resulting from model training. For example, the “full-precision” weight values may be INT8 or some other bit width with which the compute engine and/or the neural processing units 126, 128 are compatible.

The machine learning accelerator 100 is one example instantiation of a hardware accelerator that may be used to perform highly-parallelized computations that may be typical of machine learning inference, training, and/or testing (e.g., matrix multiplication, tensor products, etc.). However, it should be noted that other types of accelerator hardware may also be used (and/or may be used in combination with the machine learning accelerator 100) in accordance with the present disclosure. For example, graphics processing units (GPUs), tensor processing units (TPUs), field-programmable gate arrays (FPGAs), neural processing units (NPUs), application-specific integrated circuits (ASICs), inference accelerators, etc., may be used in various server instance configurations described herein.

The machine learning accelerator 100 (e.g., a neural network accelerator, GPU, etc.) comprises a host interface 110, a control sequencer 112, an optional processor 114 (e.g., one or more CPUs with any number of cores), an activation buffer access unit 120, a weight buffer access unit 122, a plurality of neural processing units (NPUs) 126 and 128, an output buffer access unit 130, a set of on-device memory buffers 140, and dynamic random access memory (e.g., system memory 150). The activation buffer access unit 120, the weight buffer access unit 122, the NPUs 124, 126, and 128, and the output buffer access unit 130 collectively form a compute engine 116. Along with the control sequencer 112, the compute engine 116 is responsible for executing instructions. Although a neural network accelerator (machine learning accelerator 100) is shown and described in the examples of FIG. 1, the weight vector quantization techniques described herein may be used with any machine learning hardware accelerator and/or with a general purpose processor (e.g., using software).

The machine learning accelerator 100 can be implemented as a standalone computing system or, as shown in FIG. 1, as part of a computing system comprising a host processor and system memory 182. The machine learning accelerator 100 depicted in FIG. 1 is merely an example and is not intended to unduly limit the scope of claimed embodiments. One of ordinary skill in the art would recognize many possible variations, alternatives, and modifications. For example, in some implementations, machine learning accelerator 100 may have more or fewer components than those shown in FIG. 1, may combine two or more components, or may have a different configuration or arrangement of components. The machine learning accelerator 100 generally executes one set of instructions at a time. This set of instructions is referred to herein as a “context.” At runtime, the machine learning accelerator 100 sequences and dispatches, using control sequencer 112, instructions from a pre-compiled context for execution. In certain embodiments, each context comprises a set of instructions that ends with a HALT instruction. Contexts are created by a software compiler. The instructions within a context can implement at least part of a neural network. For example, a context can correspond to a complete layer, a partial layer, or multiple layers of the neural network. In some instances, a context can correspond to a complete neural network (e.g., with instructions for an input layer, a hidden layer, and an output layer).

The host interface 110 is a communication interface to the host processor (not depicted) of the computing system. The computing system includes system memory for storing data operated on by the machine learning accelerator 100 (e.g., weights, activations, and output values corresponding to inferences). The machine learning accelerator 100 may be communicatively coupled to multiple hosts simultaneously, with any one of the hosts being able to program the machine learning accelerator 100 to execute neural network-related tasks on behalf of the host. The host interface 110 can communicate with the host processor via a standard communication protocol such as, for example, Advanced extensible Interface (AXI) protocol. Similarly, the machine learning accelerator 100 can include a separate communication interface for communicating with the on-device memory buffer(s) 140 and/or the system memory 150, e.g., to read and write data from the on-device memory buffers 140 to the system memory 150.

The control sequencer 112 is responsible for sequencing, dispatching, and finishing execution of instructions. Some instructions are executed entirely in the control sequencer 112. Other instructions may be dispatched to one or more of the NPUs 124, 126, and 128 for execution, possibly with execution results being returned to the control sequencer 112 for further processing. Still other instructions are executed by the decompression system 152 to retrieve code data from codebook 154 using index vector 156 (e.g., a quantized weight vector) and/or to decode the code data to generate the full-precision weight vector. More than one instruction can be in the execution phase at any given time within the machine learning accelerator 100. The control sequencer 112 can include an instruction memory into which instructions to be executed by the machine learning accelerator 100 are downloaded from the host processor or loaded from the system memory. In the example of FIG. 1, the host interface 110 includes a configuration memory. The configuration memory may include one or more registers that are configurable by the host processor to specify parameters relating to the context to be executed, e.g., various context dependent parameter registers (CDPRs).

In certain embodiments, the configuration memory includes a predicate register for synchronizing execution of instructions. Instructions are broadcast by the control sequencer 112 to each component of the compute engine 116 as well as the on-device memory buffers 140 and the system memory 150. Upon receipt of a broadcast instruction, a component may proceed to execute at least part of the instruction in response to determining that the component is capable of handling the instruction. For example, the system memory 150 could receive and execute a data move instruction, but the NPUs 124, 126, and 128 could ignore the data move instruction. Because instructions can execute concurrently in different components, it is useful to have a synchronization mechanism to handle any dependencies between instructions. The predicate register can be used to implement such a synchronization mechanism and, in certain embodiments, is a global register visible to internal components of the machine learning accelerator 100, as well as visible to external entities such as the host processor. Synchronization also helps to prevent conflicts in accessing the on-device memory buffers 140.

The processor 114 is an optional general purpose processor for performing certain types of processing in parallel with processing performed by the NPUs 124, 126, and 128. For example, processor 114 may include a floating point unit or other arithmetic logic unit for performing general arithmetic operations in parallel with matrix operations performed by the NPUs 124, 126, and 128.

The activation buffer access unit 120 is configured to access one or more activation buffers in the on-device memory buffers 140. In various examples, the activation buffer access unit 120 may access the decoded full-precision weight vectors decoded by the decompression system 152 using the various techniques described herein.

Similarly, the weight buffer access unit 122 and the output buffer access unit 130 are configured to access one or more weight buffers and one or more output buffers, respectively. The activations stored in the activation buffer(s) correspond to activations produced by one or more layers of a neural network being executed on the machine learning accelerator 100. The weights stored in the weight buffer(s) are synaptic weights (e.g., model parameters) associated with edges between a node of one layer and a node of another layer. Activation and weights are used for certain computations, including for instructions executed by the compute engine 116. The output buffers can store final results or intermediate results (e.g., partial sums) for access by the host processor or the system memory 150. The NPUs 124, 126, and 128 perform numerical operations using the activations and weights stored in the on-device memory buffers 140. Each NPU is configured to perform all or part of a compute instruction. Although FIG. 1 depicts the NPUs 124, 126, and 128 as block components, the NPUs 124, 126, and 128 are not necessarily identical. For example, the operations of one NPU may differ from the operations performed by another NPU.

The decompression system 152 may be used to decompress quantized weight vectors that are loaded into memory (in association with a particular model layer for which computation is to be performed). Index vector 156 is an example of such a quantized weight vector that has been loaded from system memory 150 into the on-device memory buffer(s) 140 for inference processing. However, prior to inference processing by compute engine 116, the index vector 156 is first used as an index by the decompression system 152 to lookup code data from codebook 154. The code data is then decoded using the appropriate decoding algorithm by decompression system 152 to determine the full-precision weight vector which may then be provided to the weight buffer access unit 122 for inference processing.

In various examples, the location of the decompression system 152 can vary. For example, in another embodiment, the decompression system 152 (e.g., “in-line” decompression) can be part of the compute engine 116 and is configured to decompress data stored in the on-device memory buffers 140 for input of the decompressed data to one or more of the NPUs 124, 126, and 128. Optionally, on-the-fly decompression may be used to decompress weight values in on-device memory buffer(s) 140 when loading weight values into weight buffer access unit 122.

The decompression system 152 implements a decompression pipeline. The decompression pipeline of the decompression system 152 involves processing using one or more decompression decoding techniques. The decompression system 152 can select between using one decompression scheme alone or using multiple decompression schemes in combination. For example, the decompression system 152 may decompress data using zero value decompression and then further decompress the data using shared value decompression. In the example of zero value plus shared value decompression, the order in which the compression schemes are applied can vary depending on how the decompression system 152 is implemented. Thus, zero value decompression could be performed first followed by shared value decompression. Alternatively, shared value decompression could be performed first. In general, the order in which zero value decompression and shared value decompression are performed does not matter as the resulting decompressed data would be the same irrespective of which decompression scheme is applied first.

Additionally, in various examples described herein, the decompression system 152 may select between decoding algorithms associated with different post-training weight vector quantization algorithms. A non-exhaustive list of such post-training weight vector quantization algorithms includes QuIP #, Additive Quantization for Extreme Vector Compression (AQLM), Differentiable k-means clustering compression (DKM), etc. However, the various systems and techniques described herein may use any desired weight vector compression algorithm.

In the example of FIG. 1, the decompression system 152 may be configured to receive compressed data from the system memory 150 and decompress the compressed data, using one or more decompression schemes, to generate decompressed data for storage in the on-device memory buffers 140. For example, when it is time to perform processing for a first layer of a neural network, the control sequencer 112 and/or the processor(s) 114 may load the index vector 156 from the system memory 150. The index vector 156 may be a quantized weight vector (e.g., a vector where each element represents a quantized weight for a specific neuron of the first layer of the neural network). The index vector 156 may be used to perform a lookup in the codebook 154, as described in further detail below, to determine code data associated with the index vector 156. The code data may be decoded using decompression system 152 to generate the full-precision weight vector (e.g., a vector where each element represents the full-precision weight value for a specific neuron of the first layer of the neural network) which may be accessed from the on-device memory buffer(s) 140 for processing by compute engine 116. Sending the data to the on-device memory buffer(s) 140 in compressed form (e.g., as index vector 156) and decompressing the data there reduces the amount of time required to send the data as well as the amount of data being moved.

The on-device memory buffers 140 are used to abstract the physical implementation of memories that form the activation, weight, and output buffers from NNA components (e.g., the compute engine 116 and the system memory 150) that access data in these buffers. The data in the activation, weight, and output buffers is accessed through addressing the buffers individually, with the buffer addresses being mapped to the physical addresses of the memories where the data is stored. In certain embodiments, the memories of the on-device memory buffers 140 are implemented as static random-access memory (SRAM) devices. However, the on-device memory buffers 140 can be implemented using other types of memory, both volatile and non-volatile (e.g., flash memory, DRAM, resistive RAMs, and the like). As mentioned above, the data in be stored in the on-device memory buffers 140 in compressed or decompressed form.

The NPUs 124, 126, and 128 perform numerical arithmetic operations using the activations and weights stored in the on-device memory buffers 140. Each NPU is configured to perform all or part of a compute instruction. The compute instruction may, for example, implement at least some of the computation described earlier in connection with processing by a node of a neural network, i.e., computing a weighted sum of input activations multiplied by weights, adding a bias value to the weighted sum, and then applying an activation function. Other types of computations may also be performed by the NPUs 124, 126, and 128. For example, identifying the minimum and maximum values among a first set of data values represented by a first vector and a second set of data values represented by a second vector, performing an extended multiply add, subtracting two vectors, and other types of operations applicable to data from a vector or matrix may be performed.

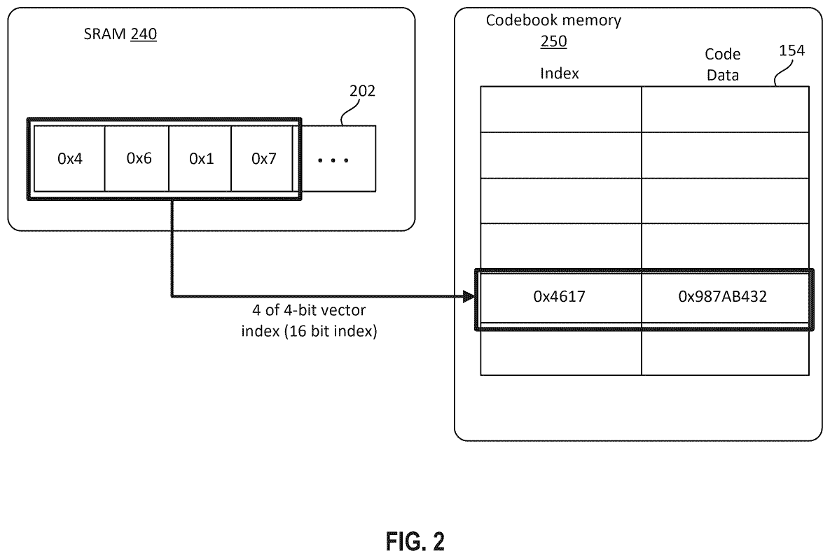

FIG. 2 depicts an example of weight vector quantization that may be used by various systems and techniques of the present disclosure. In the example of FIG. 2, the SRAM 240 may be an example of on-device memory buffer(s) 140 (of FIG. 1). However, as previously described, other types of on-device memory buffer(s) 140 may be used. Similarly, codebook memory 250 is an example of storage associated with the machine learning accelerator 100 that may store codebook 154. Codebook memory 250 may be separate from system memory 150 and/or on-device memory buffer(s) 140. However, other types of memory may instead be used (including other volatile or non-volatile memories), as desired.

In the example of FIG. 2, inference processing of a neural network may be occurring. It may be determined (e.g., by control sequencer 112 and/or processor(s) 114) that it is time to perform the compute operations for a first layer of a neural network. Accordingly, the control sequencer 112 and/or processor(s) 114 may cause the quantized weight vector 202 associated with the first layer of the neural network to be loaded from codebook memory 250 into SRAM 240. Quantized weight vector 202 may have been quantized using any desired weight vector quantization technique, as described above. Each element of the quantized weight vector 202 may be associated with the weight for a particular neuron of the first layer of the neural network. However, it should be noted that weight values (and particularly quantized weight values) may be shared for multiple neurons (within single layers and/or across multiple layers). For example, the hexadecimal value 0×4 of the left-most element of the quantized weight vector 202 may be a quantized weight value for a first neuron of the first layer of the neural network, the hexadecimal value 0×6 (element that is second-from-left) of the quantized weight vector 202 may be a quantized weight value for a second neuron of the first layer of the neural network, and so on.

In some conventional approaches for compression/decompression of weights in hardware accelerators, each quantized weight value may be used as an index into a codebook to retrieve a stored code or a stored full-precision weight value, on an element-by-element basis. For example, using such a conventional approach, the first element of the quantized weight vector 202, 0×4, may be used as a key into the codebook 154. Similarly, the second element of the quantized weight vector 202, 0×6, may separately be used as a key into the codebook 154, and so on. However, as previously described, per-weight quantization, when performed aggressively for 1-bit and 2-bit quantized weight values, results in poor model performance/accuracy when evaluated on common model benchmarks. However, weight vector quantization algorithms can be used to aggressively quantize model weights together (on a per-vector basis) leading to low bit-width (e.g., 1 or 2 bit quantized weight values) without sacrificing model performance/accuracy.

In the example of FIG. 2, the aggregated elements of the quantized weight vector 202 are used as an index into the codebook 154 (as such, quantized weight vector 202 may be referred to as an index vector (such as index vector 156 of FIG. 1)). Each element of the quantized weight vector 202 is 4 bits. If the quantized weight vector 202 has four elements (for illustrative purposes), the key value vector has 16 bits (representing the aggregated four four-bit elements). As shown, the key value vector is 0×4617 and is matched to the index 0×4617 in codebook 154 to retrieve the associated code data 0×987AB432 (which is 32 bits in the current example). The code data may be encoded using the desired weight vector quantization algorithm, as known to those skilled in the art. The code data may be loaded into SRAM 240 and decoded using decompression system 152 into the full-precision weight vector for the first layer of the neural network. The full-precision weights may then be provided to compute engine 116 for performing the computations for the first layer of the neural network. This process may be repeated for each layer of the neural network. The codebook 154 may store a relatively small amount of codes which may be decodable in the SRAM 240 to determine the full-precision model weights. Accordingly, the amount of memory required to store the model weights is greatly reduced. In addition, because the retrieved code data (32 bits in the example of FIG. 2) represents a vector of weights which can be decoded in SRAM 240, the amount of data moved between codebook memory 250 and SRAM 240 may be greatly reduced (relative to a scenario in which the full-precision model weights were loaded from system memory 150 to SRAM 240).

For example, if the decoded, full-precision weights are each 32 bits (which are each compressed to 4 bits in the quantized weight vector 202), the code data 0×987AB432 may be moved from codebook memory 250 to SRAM 240. This involves loading 32 bits into SRAM 240. However, since the code data 0×987AB432 may be decoded in SRAM 240 into four 32-bit weights, a 4× reduction in the amount of memory moved is achieved. As described in further detail below, the decompression system 152 may be instantiated in such a way as to be agnostic to the particular decoding algorithm that is used to decode the retrieved code data into the full-precision weight values.

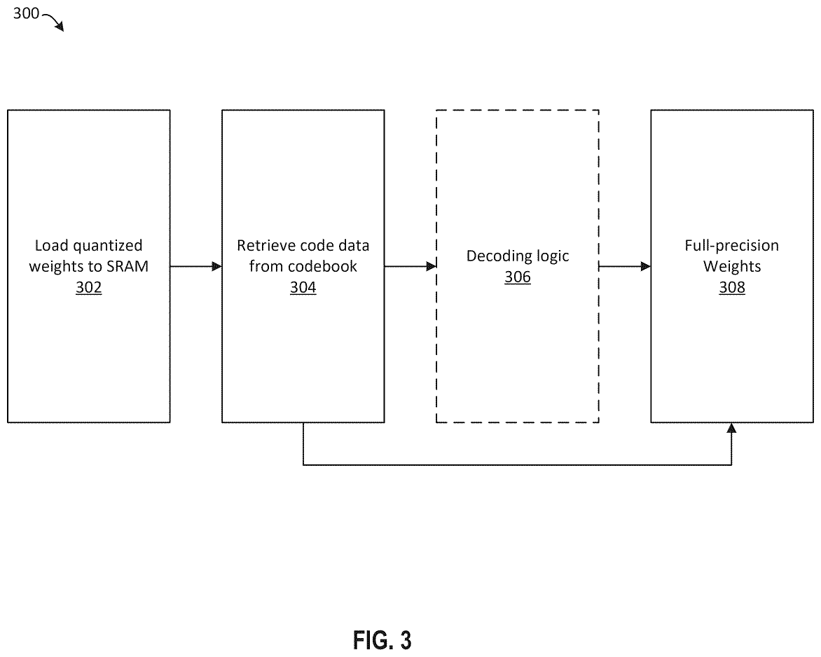

FIG. 3 depicts an example process 300 for weight loading and decoding, in accordance with various examples of the present disclosure. The actions of the process 300 may represent a series of instructions comprising computer readable machine code executable by a processing unit of an image signal processor, although various operations may be implemented in hardware. In various examples, the computer readable machine codes may be comprised of instructions selected from a native instruction set of the processor(s) and/or an operating system of the computing device.

Processing may start at action 302 at which quantized weights (e.g., the quantized weight vector for the particular layer of the machine learning model being evaluated) may be loaded from storage (e.g., system memory 150) into the on-device memory buffers 140 (e.g., SRAM). Processing may continue at action 304 at which the code data may be retrieved from the codebook (e.g., codebook 154) using the quantized weight vector as the index vector 156 to perform the lookup.

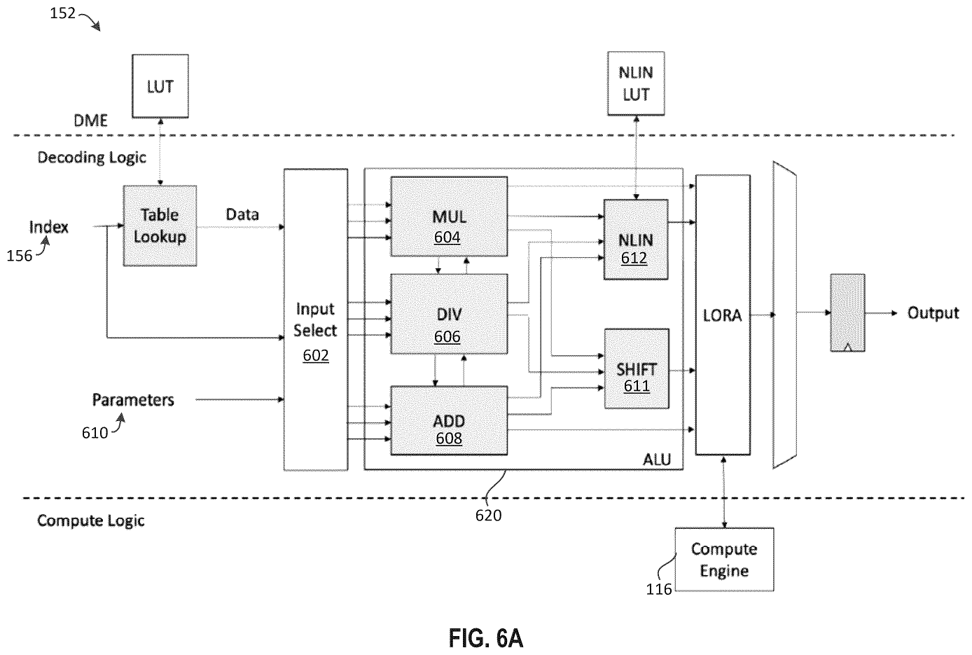

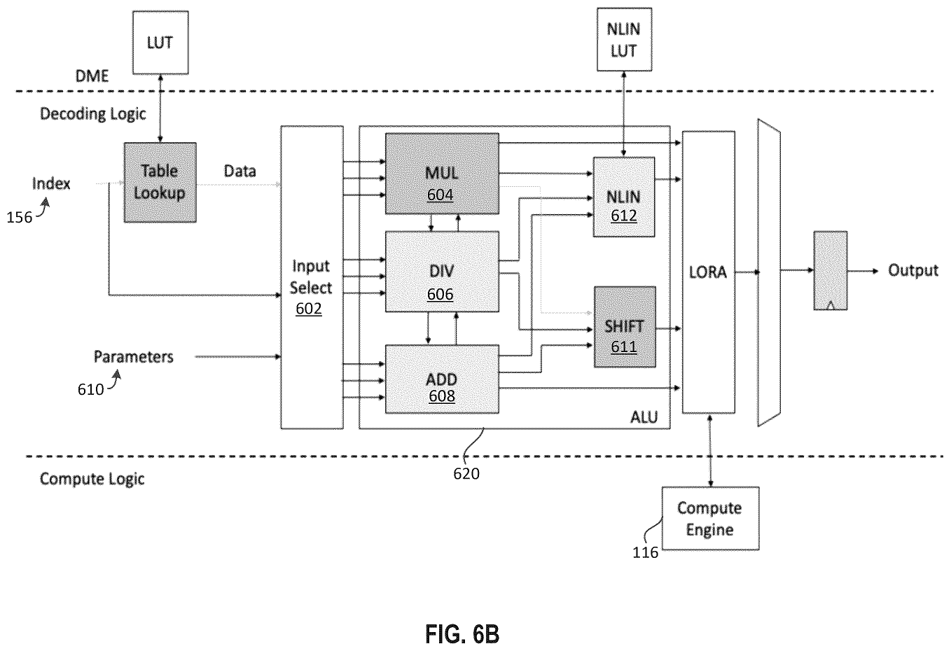

In some examples, the code data retrieved at action 304 may be directly used as the weights by the compute engine 116. For example, if the weight vector quantization algorithm used to compress the weights is DKM, the retrieved codes may be directly used as the full-precisions weight values during compute. As such, action 306 (“decoding logic”) may be optional depending on the specific weight vector quantization algorithm used (which in turn may depend on the specific machine learning model being executed by the machine learning accelerator 100). As described in further detail below in reference to FIGS. 6A, 6B, the architecture of the decompression system 152 may be configured to decode retrieved codes (or pass through data when decoding is not needed) for any desired weight vector quantization algorithm. In cases in which the code data is to be decoded to determine the full-precision weight values used for compute, the retrieved code data may be decoded at action 306.

For example, in QuIP #, the decoding logic may be as follows:
1. Perform a MUL operation to flip the bits of the code data.
2. Perform a shift operation on the last bit of the result.
3. Move the data into the weight buffer for matrix multiplication by one or more of the neural processing units 126, 128.

An example of the above QuIP #decoding is shown in FIG. 6B.

It should be noted that the specific decoding algorithm employed by decompression system 152 may vary according to the specific weight vector quantization algorithm used. After decoding, processing may continue to action 308, at which the full-precision weights may be moved to the compute engine 116 for matrix multiplication. In cases where the retrieved code data (from action 304) are directly used as the full-precision weight values, the code data may be moved to the compute engine 116 for matrix multiplication. Additionally, although the hardware architectures depicted in FIGS. 6A, 6B may be used in accordance with example implementations, it should be noted that other configurable (e.g., programmable) hardware architectures may be used to decode the retrieved code data into full precision weight values in accordance with the specific quantization algorithm that has been used. Additionally, in some examples, the decoding logic(s) may be implemented using software.

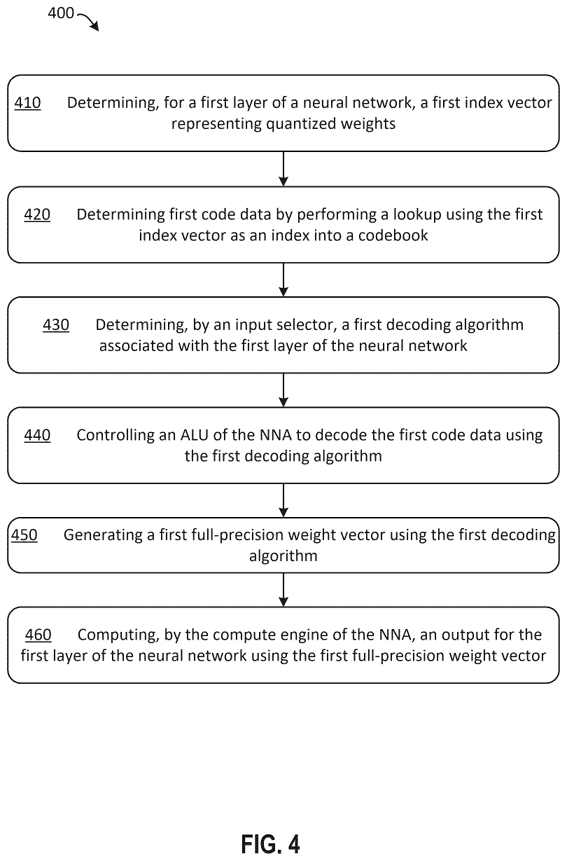

FIG. 4 depicts an example process 400 for determining a full precision weight vector from a quantized index weight vector for inference processing, in accordance with various aspects of the present disclosure. The actions of the process 400 may represent a series of instructions comprising computer readable machine code executable by one or more processors, although various operations may be implemented in other hardware. In various examples, the computer readable machine codes may be comprised of instructions selected from a native instruction set of the processor(s) and/or an operating system of the computing device.

Process 400 may begin at action 410, at which a first index vector may be determined for a first layer of a neural network. The first index vector may represent quantized weights. For example, when it is time to compute the activation values for the first layer of the neural network (e.g., during inference processing), the quantized weight vector used to calculate these activation values may be loaded into the on-device memory buffer(s) of the hardware accelerator (e.g., on-device memory buffer(s) 140, such as SRAM) from system memory 150 and/or other storage. The quantized weight vector may be quantized using a weight vector quantization algorithm (e.g., AQLM, DKM, QuIP #, etc.). Each element of the quantized weight vector (e.g., the first index vector) may represent a respective quantized weight value for a neuron of the first layer of the neural network.

Processing may continue at action 420, at which first code data may be determined by performing a lookup using the first index vector as an index into a codebook. For example, the first index vector (e.g., quantized weight vector 202 of FIG. 2) may be used as an index into codebook 154 to retrieve the first code data (e.g., 0x987AB432 in FIG. 2). The first code data may be loaded into the on-device memory buffers (e.g., SRAM).

Processing may continue at action 430, at which an input selector may determine a first decoding algorithm associated with the first layer of the neural network. For example, the model weights for the first neural network may be compressed using a particular weight vector compression algorithm (e.g, DKM, AQLM, QuIP #, etc.). Accordingly, an input selector (e.g., input selector 602 of decompression system 152 described below in reference to FIG. 6A) may select the corresponding first decoding algorithm that can be used to decode the code data into the full-precision weight values using the decompression system 152.

Processing may continue at action 440, at which an arithmetic logic unit (ALU) of the decompression system 152 may be controlled to decode the first code data using the first decoding algorithm. For example, as shown below in the example of FIG. 6B, for QuIP #, the input selector 602 may first control an MUL component of the ALU to flip the bits of the code data, followed by performing a shift operation on the last bit (using Shift component 606), before moving the decoded full-precision data into the compute engine 116 for computation. The decoding operation of action 440 may be performed on the code data while the code data is stored in the on-device memory buffer(s) 140 to reduce the amount of data moved between system memory 150 and the on-device memory buffer(s) 140.

Processing may continue at action 450, at which a first full-precision weight vector may be generated using the first decoding algorithm. As described above, the operations of action 440 (e.g., the MUL operation and the SHIFT operation for a QuIP #decoding) may be performed in parallel for each weight value to generate the first full-precision weight vector. Processing may continue at action 460, at which the compute engine (e.g., compute engine 116) of the NNA (or other hardware accelerator) may generate an output for the first layer of the neural network using the first full-precision weight vector (e.g., by performing matrix multiplication, etc., for the forward pass of the neural network).

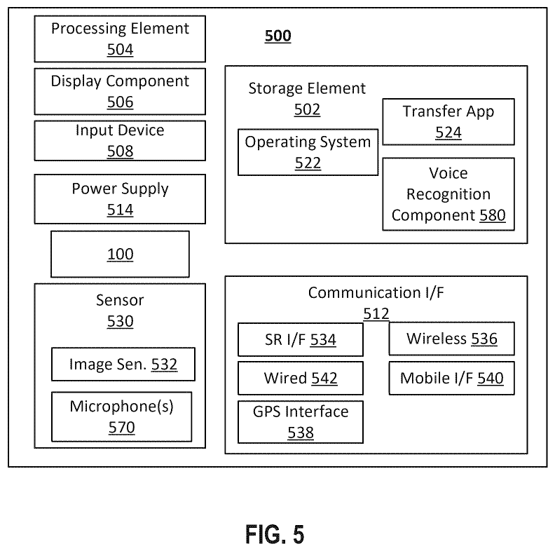

FIG. 5 is a block diagram showing an example architecture 500 of a network-connected device, such as an apparatus that may include the machine learning accelerator 100. In various examples, it may be advantageous to deploy the machine learning accelerator 100 in network edge devices and/or resource constrained devices (such as a device including all or some portion of the components of architecture 500) as the machine learning accelerator 100 may lower computational requirements for model execution (e.g., for machine learning model inference).

It will be appreciated that not all devices will include all of the components of the architecture 500 and some user devices may include additional components not shown in the architecture 500. The architecture 500 may include one or more processing elements 504 for executing instructions and retrieving data stored in a storage element 502. The processing element 504 may comprise at least one processor. Any suitable processor or processors may be used. For example, the processing element 504 may comprise one or more digital signal processors (DSPs). In some examples, the processing element 504 may be effective to determine a wakeword and/or to stream audio data to a speech processing system. The storage element 502 can include one or more different types of memory, data storage, or computer-readable storage media devoted to different purposes within the architecture 500. For example, the storage element 502 may comprise flash memory, random-access memory, disk-based storage, etc. Different portions of the storage element 502, for example, may be used for program instructions for execution by the processing element 504, storage of images or other digital works, and/or a removable storage for transferring data to other devices, etc.

The storage element 502 may also store software for execution by the processing element 504. An operating system 522 may provide the user with an interface for operating the computing device and may facilitate communications and commands between applications executing on the architecture 500 and various hardware thereof. A transfer application 524 may be configured to receive images, audio, and/or video from another device (e.g., a mobile device, image capture device, and/or display device) or from an image sensor 532 and/or microphone 570 included in the architecture 500. In some examples, the transfer application 524 may also be configured to send the received voice requests to one or more voice recognition servers.

When implemented in some user devices, the architecture 500 may also comprise a display component 506. The display component 506 may comprise one or more light-emitting diodes (LEDs) or other suitable display lamps. Also, in some examples, the display component 506 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 506 may be effective to display content determined provided by a skill executed by the processing element 504 and/or by another computing device. In some examples, the display component 506 and/or one or more speakers (not shown) may be effective to output an indication that unconsumed notifications (e.g., voice notifications) are pending. In some cases, there may be an indicator light effective to provide such an indication. In addition, speakers of the architecture 500 may output the voice notification audio upon receiving a user command to consume or “read” the voice notifications.

The architecture 500 may also include one or more input devices 508 operable to receive inputs from a user. The input devices 508 can include, for example, a push button, touch pad, touch screen, wheel, joystick, keyboard, mouse, trackball, keypad, light gun, game controller, or any other such device or element whereby a user can provide inputs to the architecture 500. These input devices 508 may be incorporated into the architecture 500 or operably coupled to the architecture 500 via wired or wireless interface. In some examples, architecture 500 may include a microphone 570 or an array of microphones for capturing sounds, such as voice requests. Voice recognition component 580 may interpret audio signals of sound captured by microphone 570. In some examples, voice recognition component 580 may listen for a “wakeword” to be received by microphone 570. Upon receipt of the wakeword, voice recognition component 580 may stream audio to a voice recognition server for analysis, such as a speech processing system. In various examples, voice recognition component 580 may stream audio to external computing devices via communication interface 512.

When the display component 506 includes a touch-sensitive display, the input devices 508 can include a touch sensor that operates in conjunction with the display component 506 to permit users to interact with the image displayed by the display component 506 using touch inputs (e.g., with a finger or stylus). The architecture 500 may also include a power supply 514, such as a wired alternating current (AC) converter, a rechargeable battery operable to be recharged through conventional plug-in approaches, or through other approaches such as capacitive or inductive charging.

The communication interface 512 may comprise one or more wired or wireless components operable to communicate with one or more other computing devices. For example, the communication interface 512 may comprise a wireless communication module 536 configured to communicate on a network, such as a computer communication network, according to any suitable wireless protocol, such as IEEE 802.11 or another suitable wireless local area network (WLAN) protocol. A short range interface 534 may be configured to communicate using one or more short range wireless protocols such as, for example, near field communications (NFC), Bluetooth, Bluetooth LE, etc. A mobile interface 540 may be configured to communicate utilizing a cellular or other mobile protocol. A Global Positioning System (GPS) interface 538 may be in communication with one or more earth-orbiting satellites or other suitable position-determining systems to identify a position of the architecture 500. A wired communication module 542 may be configured to communicate according to the USB protocol or any other suitable protocol.

The architecture 500 may also include one or more sensors 530 such as, for example, one or more position sensors, image sensors, and/or motion sensors. An image sensor 532 is shown in FIG. 5. An example of an image sensor 532 may be a camera configured to capture color information, image geometry information, and/or ambient light information.

FIG. 6A depicts an example of the decompression system 152 of FIG. 1 that may be included in an example machine learning accelerator architecture, in accordance with various aspects of the present disclosure. Index vector 156 may be loaded into on-device memory (e.g., SRAM) from DRAM and may be used to perform a lookup (e.g., in the lookup table (LUT) which may store codebook 154) to determine the code associated with the index vector 156 (e.g., a vector of quantized weights quantized using weight vector quantization). Parameters 610 may provide metadata about the current model being executed (e.g., including metadata identifying the weight quantization algorithm used to generate the index vector 156. Accordingly, input selector 602 may determine (e.g., based on parameters 610) the appropriate decoding algorithm to use to decode the code data retrieved from the codebook (in the LUT) into the full-precision weight vector.

Accordingly, the input selector 602 may control the arithmetic logic unit (ALU) 620 to perform the relevant decoding operations on the input code data. FIG. 6B depicts an example usage of the decompression system 152 for decoding full precision weights from quantized weights, quantized using the Quantization with incoherence processing (QuIP #) algorithm, in accordance with an example of the present disclosure. For example, the parameters 610 may indicate that QuIP #decoding algorithm should be used to decode the code data into the full-precision weight vector. Accordingly, the input selector 602 may first send machine instructions to the MUL 604 to perform a MUL operation to flip the bits of the code data. The data may be sent to the SHIFT component 611 to perform a shift operation on the last bit of the result. The resulting weight vector (the operations may be performed in parallel) may be moved into the compute engine 116 for compute (e.g., matrix multiplication). Compute engine 116 may have access to low rank adaptation (LoRA) to add low-rank matrices to a pre-trained model in order to adapt the model to specific tasks (as desired). As shown, the ALU 620 also comprises other components that can be used for other decoding logics (e.g., apart from QuIP #). For instance, the ALU 620 may include a divider component (DIV) 606 for performing division, an adder component (ADD) 608 for performing addition and/or subtraction, a non-linear component (NLIN) 612 (e.g., for performing non-linear operations such as non-linear activation functions), etc. These components may be implemented using application specific integrated circuits (ASICs) and/or programmable circuitry, as desired. The decoding logic and components of ALU 620 that are used for a given decoding operation may depend on the specific quantization technique used to generate the compressed weight vector (e.g., index vector 156). In some instances, such as the DKM weight vector quantization algorithm, the retrieved codes may be used as the full-precision weight values.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon applying one or more data signals, application specific integrated circuits having appropriate logic gates, or other components, etc. Such technologies are generally well known by those of ordinary skill in the art and consequently, are not described in detail herein.

As used herein (e.g., including in the claims of the application), the terms “first”, “second”, and so forth, do not necessarily imply a particular order of events or elements, but are used to distinguish individual elements from one another. For example, the language a “first layer” of a machine learning model does not necessarily mean that the layer is the initial layer of the model. Instead, the adjective “first” may merely be intended to distinguish the layer from other layers such as a “second” layer. In fact, in various examples, the second layer may precede the first layer and there may be any number of intervening layers between the “first layer” and the “second layer.”

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or other type of application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A system comprising:
a neural network accelerator apparatus comprising:
one or more processors;
an arithmetic logic unit (ALU);
a compute engine;
an input selector; and
one or more computer readable media comprising static random access memory (SRAM), the one or more computer readable media storing processor executable instructions which, when executed using the one or more processors, perform operations comprising:
determining, for a first layer of a neural network, a first index vector stored in the SRAM, wherein a first element of the first index vector comprises a first hexadecimal value and a second element of the first index vector comprises a second hexadecimal value;
determining first code data by performing a lookup using the first index vector as an index into a codebook;
determining, by the input selector, a first decoding algorithm associated with the first index vector;
programming, by the input selector, the ALU to decode the first code data using the first decoding algorithm;
generating, by the ALU, a first full-precision weight vector by decoding the first code data, wherein each element of the first full-precision weight vector represents a respective full-precision weight for the first layer of the neural network; and
computing, by the compute engine, an output for the first layer of the neural network using the full-precision weights of the first full-precision weight vector.

2. The system of claim 1, wherein the one or more computer readable media store further processor executable instructions which, when executed using the one or more processors, perform operations further comprising:
loading the first index vector from system memory to the SRAM, wherein the first index vector comprises reduced-precision weight values quantized using vector quantization from the first full-precision weight vector.

3. The system of claim 1, wherein the first decoding algorithm comprises a Quantization with Incoherence Processing (QuIP #) algorithm.

4. A system comprising:
a neural network accelerator apparatus comprising:
one or more processors; and
one or more computer readable media storing processor executable instructions which, when executed using the one or more processors, perform operations comprising:
determining, for a first layer of a neural network, a first index vector stored in volatile memory;
determining first code data by performing a lookup using the first index vector as an index into a codebook;
determining a first weight vector by decoding the first code data using a first decoding algorithm, wherein each element of the first weight vector represents a respective weight for the first layer of the neural network; and
computing an output for the first layer of the neural network using the weights of the first weight vector.

5. The system of claim 4, wherein the system comprises an input selector configured to determine the first decoding algorithm associated with the first layer of the neural network.

6. The system of claim 5, further comprising an arithmetic logic unit (ALU), wherein the one or more computer readable media stores further processor executable instructions which, when executed using the one or more processors, perform operations further comprising:
programming, by the input selector, the ALU according to the first decoding algorithm, wherein the ALU determines the first weight vector by decoding the first code data.

7. The system of claim 4, wherein the one or more computer readable media stores further processor executable instructions which, when executed using the one or more processors, perform operations further comprising:
loading the first index vector from system memory to static random access memory (SRAM), wherein the first index vector comprises reduced-precision weight values quantized using vector quantization from the first weight vector.

8. The system of claim 4, wherein the one or more computer readable media stores further processor executable instructions which, when executed using the one or more processors, perform operations further comprising:
loading the first code data from system memory to static random access memory (SRAM), wherein the codebook is stored in the system memory.

9. The system of claim 4, wherein a respective value of each element of the first index vector represents a respective quantized weight of the first layer of the neural network.

10. The system of claim 9, wherein each respective value is quantized using vector quantization to less than four bits.

11. The system of claim 4, wherein the first decoding algorithm is associated with a Quantization with incoherence processing (QuIP #) algorithm or an additive quantization for vector compression algorithm.

12. The system of claim 4, wherein neural network accelerator apparatus further comprises:
an input selector;
an arithmetic logic unit; and
a compute engine;
the input selector configured to:
determine the first decoding algorithm associated with the first layer of the neural network; and
control the arithmetic logic unit to decode the first code data using the first decoding algorithm.

13. A method comprising:
determining, for a first layer of a neural network, a first index vector stored in volatile memory;
determining first code data by performing a lookup using the first index vector as an index into a codebook;
determining a first weight vector by decoding the first code data using a first decoding algorithm, wherein each element of the first weight vector represents a respective weight for the first layer of the neural network; and
computing an output for the first layer of the neural network using the weights of the first weight vector.

14. The method of claim 13, comprising selecting, by an input selector of a neural network accelerator apparatus, the first decoding algorithm associated with the first layer of the neural network.

15. The method of claim 14, comprising:
programming, by the input selector, an arithmetic logic unit of the neural network accelerator apparatus according to the first decoding algorithm, wherein the arithmetic logic unit determines the first weight vector by decoding the first code data.

16. The method of claim 13, comprising:
loading the first index vector from system memory to static random access memory (SRAM), wherein the first index vector comprises reduced-precision weight values quantized using vector quantization from the first weight vector.

17. The method of claim 13, comprising:
loading the first code data from system memory to static random access memory (SRAM), wherein the codebook is stored in the system memory.

18. The method of claim 13, wherein a respective value of each element of the first index vector represents a respective quantized weight of the first layer of the neural network.

19. The method of claim 18, wherein each respective value is quantized using vector quantization to less than four bits.

20. A method comprising:
determining, for a first layer of a neural network, a first index vector stored in volatile memory;
determining first code data by performing a lookup using the first index vector as an index into a codebook;
determining a first activation vector by decoding the first code data using a first decoding algorithm, wherein each element of the first activation vector represents a respective activation value for the first layer of the neural network; and
computing an output for the first layer of the neural network using the activation values of the first activation vector.
